(19) United States
(12) Patent Application Publication
(10) Pub. No.: US 2019/0362350 A1
(43) Pub. Date: Nov. 28, 2019

(54) COMPUTER SYSTEM AND COMPUTER-IMPLEMENTED METHOD FOR PROCESSING AN ELECTRONIC COMMERCE PAYMENT TRANSACTION

(71) Applicant: MASTERCARD INTERNATIONAL INCORPORATED, Purchase, NY (US)

(72) Inventor: Abhay MANDLOI, Pune (IN)

(21) Appl. No.: 16/421,010

(22) Filed: May 23, 2019

(30) Foreign Application Priority Data
May 25, 2018 (SG) 10201804462Q

(51) Int. Cl. G06Q 20/40; G06Q 20/38; G06Q 20/10; G06Q 20/12

(52) U.S. Cl. CPC G06Q 20/4014; G06Q 20/12; G06Q 20/10; G06Q 20/3821

(57) ABSTRACT

A payment network server for processing an electronic commerce (e-commerce) payment transaction initiated by a customer at a merchant portal is described. The server comprises a transaction module and an authorization request module. The transaction module is configured to: receive, from a merchant server associated with the merchant portal, a payment transaction request comprising a customer account number, a customer-to-merchant identifier, and a payment amount; and transmit, to the merchant server, a payment transaction response comprising an approval or refusal for the e-commerce payment transaction. The authorization request module is configured to: transmit, to an issuer server associated with the issuer institution maintaining the customer account, a request for authorization to proceed with the e-commerce payment transaction, where the request for authorization comprises the customer account number and the customer-to-merchant identifier for the issuer server to verify, such that the e-commerce payment transaction is authorized if both are verified.

### TECHNICAL FIELD

The present invention relates to a computer system and computer-implemented method for processing an electronic commerce (e-commerce) payment transaction. In particular, the invention relates to authenticating an e-commerce payment transaction initiated through a merchant portal.

### BACKGROUND

To better protect an electronic commerce (e-commerce) payment transaction from fraud, a customer is typically required to provide a significant amount of detail for authenticating the e-commerce payment transaction. Generally, card details such as a card number, a name of the card holder, an expiry date of the card and a card verification code (CVC) are required. These details may not be readily available to the customer at the time of initiating the e-commerce payment transaction, and it may be inconvenient for the customer to retrieve these details for the e-commerce payment transaction.

Moreover, in an event where enhanced security is required for the e-commerce payment transaction, a one-time-password (OTP) may be sent to the customer via a second communication means e.g. an email or a mobile device for authentication. This translates to more resources spent and more processing time required for authenticating the e-commerce payment transaction. If the customer is unable to access the OTP (e.g. due to a poor reception of his mobile device), the customer may not even be able to complete the e-commerce payment transaction.

It is therefore an aim of the present invention to provide a computer system and computer-implemented method to improving convenience while maintaining a balanced level of security for authenticating an e-commerce payment transaction.

### BRIEF SUMMARY

In accordance with a first aspect of the present invention, there is provided a payment network server for processing an electronic commerce (e-commerce) payment transaction initiated by a customer at a merchant portal. The payment network server comprising:

a transaction module configured to:
receive, from a merchant server associated with the merchant portal, a payment transaction request comprising a customer account number, a customer-to-merchant identifier and a payment amount, the customer account number being associated with a customer account maintained at an issuer institution and the customer-to-merchant identifier being associated with a customer service account maintained by the merchant server and being pre-registered with an issuer database against the customer account number prior to the payment transaction request; and
transmit, to the merchant server, a payment transaction response comprising an approval or a refusal for the e-commerce payment transaction; and

an authorization request module configured to:
transmit, to an issuer server associated with the issuer institution, a request for authorization to proceed with the e-commerce payment transaction, the request for authorization comprising at least the customer account number and the customer-to-merchant identifier for the issuer server to verify the customer account number and the customer-to-merchant identifier against respective entries in the issuer database, such that the e-commerce payment transaction is authorized if the customer account number and the customer-to-merchant identifier are verified.

Embodiments of the invention therefore provide a payment network server that can be used for processing an e-commerce payment transaction initiated by a customer at a merchant portal. In particular, to process the e-commerce payment transaction, a customer account number, a customer-to-merchant identifier and a payment amount are required to be provided to the payment network server. The customer-to-merchant identifier is associated with a customer service account maintained by the merchant server and is pre-registered with an issuer database against the customer account number prior to the initiation of the e-commerce payment transaction. The customer account number and the customer-to-merchant identifier are verified before the e-commerce payment transaction is authorized to proceed. In some embodiments, no further authentication process (e.g. one-time password (OTP), card verification code (CVC) etc.) is necessary. The e-commerce payment transaction is authorized simply based on a verification of the pre-registered customer-to-merchant identifier and the customer account number. This advantageously minimizes processing time for an e-commerce payment transaction by at least reducing a number of processing steps (e.g. a step of authorization involving an OTP), increasing convenience for the customer, while maintaining a balanced level of security for authenticating the e-commerce payment transaction (since only a pre-registered customer-to-merchant identifier will be recognized).

In addition, embodiments of the invention advantageously use present infrastructure for processing the e-commerce payment transaction using the customer-to-merchant identifier so that minimal costs will be incurred to implement the above. The primary set-up required is to maintain records of customer-to-merchant identifiers against customer account numbers at the issuer server which can be easily implemented using existing memory storages, servers and/or databases.

The payment network server may comprise a registration request module configured to:

receive, from a customer electronic device, a registration request comprising the customer account number and the customer-to-merchant identifier, the registration request being a request to permit authorization of the e-commerce payment transaction through the verification of the customer account number and the customer-to-merchant identifier;

transmit, the registration request to the issuer server;

receive, a registration response from the issuer server, the registration response indicating if the registration request is approved or refused, the customer-to-merchant identifier is registered against the customer account number in the issuer database associated with the issuer server if the registration request is approved; and transmit, the registration response to the customer electronic device.

In accordance with a second aspect of the present invention, there is provided a computer-implemented method performed at a payment network server for processing an electronic commerce (e-commerce) payment transaction initiated by a customer at a merchant portal, the method comprising:

receiving, from a merchant server associated with the merchant portal, a payment transaction request comprising a customer account number, a customer-to-merchant identifier and a payment amount, the customer account number being associated with a customer account maintained at an issuer institution and the customer-to-merchant identifier being associated with a customer service account maintained by the merchant server and being pre-registered with an issuer database against the customer account number prior to the payment transaction request;

transmitting, to an issuer server associated with the issuer institution, a request for authorization to proceed with the e-commerce payment transaction, the request for authorization comprising at least the customer account number and the customer-to-merchant identifier for the issuer server to verify the customer account number and the customer-to-merchant identifier against respective entries in the issuer database such that the e-commerce payment transaction is authorized if the customer account number and the customer-to-merchant identifier are verified; and

transmitting, to the merchant server, a payment transaction response comprising an approval or a refusal for the e-commerce payment transaction.

The method may comprise:

receiving, from a customer electronic device, a registration request comprising the customer account number and the customer-to-merchant identifier, the registration request being a request to permit authorization of the e-commerce payment transaction through the verification of the customer account number and the customer-to-merchant identifier;

transmitting, the registration request to the issuer server;

receiving, a registration response from the issuer server, the registration response indicating if the registration request is approved or refused, the customer-to-merchant identifier is registered against the customer account number in the issuer database associated with the issuer server if the registration request is approved; and

transmitting, the registration response to the customer electronic device.

In accordance with a third aspect of the present invention, there is provided an issuer server for processing an electronic commerce (e-commerce) payment transaction initiated by a customer at a merchant portal, the server comprising:

a registration module configured to:
receive, from a customer electronic device, a registration request comprising at least a customer account number and a customer-to-merchant identifier, the customer account number being associated with a customer account maintained at an issuer institution associated with the issuer server and the customer-to-merchant identifier being associated with a customer service account maintained by a merchant server associated with the merchant portal; and
transmit, to the customer electronic device, a registration response indicating if the registration request is approved or refused, the customer-to-merchant identifier is registered against the customer account number in an issuer database if the registration request is approved; and

an authorization module configured to:
receive, from a payment network server, a request for authorization to proceed with the e-commerce payment transaction, the request for authorization comprising at least the customer account number and the customer-to-merchant identifier;
verify the customer account number and the customer-to-merchant identifier against respective entries registered in the issuer database; and
authorize the e-commerce payment transaction if the customer account number and the customer-to-merchant identifier are verified.

In accordance with a fourth aspect of the present invention, there is provided a computer-implemented method performed at an issuer server for processing an electronic commerce (e-commerce) payment transaction initiated by a customer at a merchant portal, the method comprising:

receiving, from a customer electronic device, a registration request comprising at least a customer account number and a customer-to-merchant identifier, the customer account number being associated with a customer account maintained at an issuer institution associated with the issuer server and the customer-to-merchant identifier being associated with a customer service account maintained by a merchant server associated with the merchant portal;

transmitting, to the customer electronic device, a registration response indicating if the registration request is approved or refused, the customer-to-merchant identifier is registered against the customer account number in an issuer database if the registration request is approved;

receiving, from a payment network server, a request for authorization to proceed with the e-commerce payment transaction, the request for authorization comprising at least the customer account number and the customer-to-merchant identifier;

verifying the customer account number and the customer-to-merchant identifier against respective entries registered in the issuer database; and

authorizing the e-commerce payment transaction if the customer account number and the customer-to-merchant identifier are verified.

The payment transaction response may comprise the customer-to-merchant identifier.

The customer account number may be associated with a plurality of customer-to-merchant identifiers.

The e-commerce payment transaction may be associated with a post-payment for goods and/or services used.

The customer-to-merchant identifier may be one of the following: a customer service account number, a name of the customer, a mobile number of the customer, a security number, an identity card number, a passport number, and a string of one or more alphanumeric symbols or characters.

In accordance with a fifth aspect of the present invention, a non-transitory computer-readable medium having stored thereon program instructions for causing at least one processor to perform any one of the preceding methods.

Embodiments of the present invention aims to provide a new and useful computer system and computer-implemented method to improving convenience while maintaining a balanced level of security for authenticating an e-commerce payment transaction.

### BRIEF DESCRIPTION OF THE DRAWINGS

Non-limiting embodiments of the invention will now be described for the sake of example only, with reference to the following drawings in which:

FIG. 1 shows a computerized system for processing an electronic commerce (e-commerce) payment transaction initiated by a customer at a merchant portal in accordance with an embodiment of the invention;

FIG. 2 shows steps of a method performed at a payment network server for processing an e-commerce payment transaction initiated by a customer at a merchant portal in accordance with an embodiment of the invention;

FIG. 3 shows steps of a method performed at a payment network server for registering a customer-to-merchant identifier for use in an e-commerce payment transaction in accordance with an embodiment of the invention;

FIG. 4 shows steps of a method performed at an issuer server for processing an e-commerce payment transaction initiated by a customer at a merchant portal in accordance with an embodiment of the invention;

FIG. 5 shows schematically a functional structure of the payment network server which may be used in the computerized system as shown in FIG. 1 in accordance with an embodiment of the invention;

FIG. 6 shows schematically a functional structure of the issuer server which may be used in the computerized system as shown in FIG. 1 in accordance with an embodiment of the invention; and

FIG. 7 shows schematically a hardware structure of a server which may be used in the computerized system of FIG. 1 to implement a method in accordance with an embodiment of the invention.

### DETAILED DESCRIPTION

As used in this document, the term “account” refers to any payment account maintained by a financial institution, the account may be associated with a payment vehicle such as a credit card, a debit card, a prepaid card, a charge card, a membership card, a promotional card, a frequent flyer card, an identification card, a prepaid card, a gift card, and/or any other payment device that may hold payment account information, such as mobile phones, Smartphones, personal digital assistants (PDAs), key fobs, transponder devices, near field communication (NFC)-enabled devices, and/or computers.

As used in this document, the term “payment card” refers to any electronic cashless payment vehicle associated with an account.

As used in this document, the term “customer-to-merchant identifier” refers to any identifier associated with a customer service account maintained by a merchant which allows the merchant to identify the customer service account. A customer-to-merchant identifier may be a customer service account number, a name of the customer, a mobile number of the customer, a security number, an identity card number, a passport number, a string of one or more alphanumeric symbols or characters etc. as long as it enables the merchant to uniquely identify the customer service account.

Note that the term “institution” is used here in a sense which is not necessarily limited to organizations which are legally constituted as banks, since in some jurisdictions other organizations may be permitted to maintain financial accounts such as a payment card account. An institution may be one of the following: a bank, a financial technology company, a telecommunication company or a financial institution.

As used in this application, the terms “component,” “module,” “system,” “apparatus,” “interface,” or the like are generally intended to refer to a computer-related entity, either hardware, a combination of hardware and software, software, or software in execution. For example, a component or a module may be, but is not limited to being, a process running on a processor, a processor, an object, an executable, a thread of execution, a program, and/or a computer. By way of illustration, both an application running on a controller and the controller can be a component or a module. One or more components/modules may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

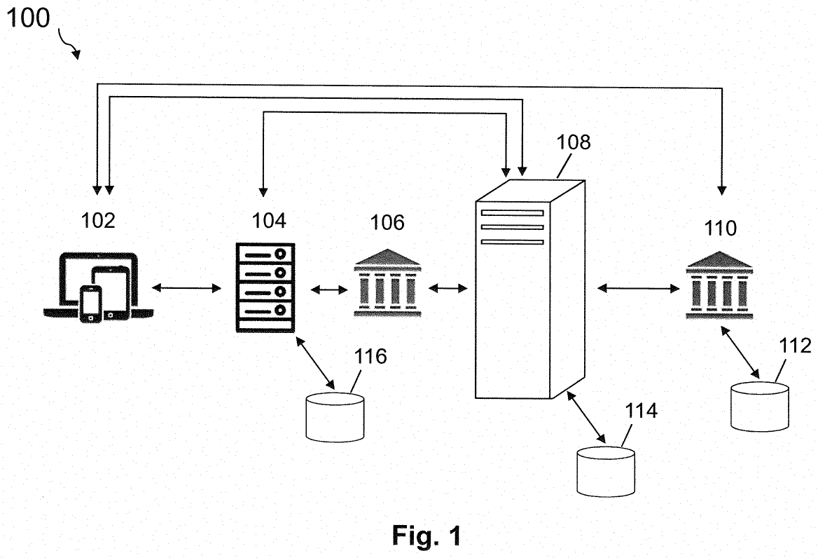

FIG. 1 shows a computerized system 100 for processing an electronic commerce (e-commerce) payment transaction initiated by a customer at a merchant portal in accordance with an embodiment of the invention. The computerized system 100 comprises a customer electronic device 102, a merchant server 104, an acquirer server 106, a payment network server 108, and an issuer server 110. The payment network server 108 facilitates a payment transaction between a customer and a merchant. The payment network server 108 is a server associated with a payment network such as the Banknet payment network operated by Mastercard®. As shown in FIG. 1, the payment network server 108 is in communication with the acquirer server 106 and the issuer server 110. In some embodiments, the payment network server 108 is in communication with the customer electronic device 102 (e.g. via a portal hosted by the payment network server 108). The acquirer server 106 is operated by an acquirer institution at which the merchant maintains a merchant account to receive funds. The issuer server 110 is associated with an issuer institution which maintains accounts and provides payment cards to customers for performing payment transactions (e.g. e-commerce payment transactions) over the payment network. In some embodiments, the issuer server 110 is configured to communicate directly with the customer electronic device 102 (e.g. via Short Message Service (SMS) or electronic mail etc.). The customer electronic device 102 may be any electronic device which enables the customer to purchase or make payment for good(s) and/or service(s) online through e-commerce sites (e.g. the merchant portal). The customer electronic device 102 may be a mobile phone, a laptop/notebook, a desktop, a tablet, a personal digital assistant (PDA), a key fob, a transponder device, an NFC-enabled device, and/or a computer. The merchant server 104 is associated with the merchant portal on which the e-commerce payment transaction is initiated. In some embodiments, the merchant server 104 is in communication with the payment network server 108 via a payment gateway (not shown). The payment gateway may be hosted by the payment network server 108. Moreover, an issuer database 112 is operationally connected to the issuer server 110. The issuer database 112 serves at least to store data related to customer accounts maintained by the issuer institution (e.g. customer account numbers, balance of the customer accounts etc.) and customer-to-merchant identifiers. In some embodiments, the issuer database 112 may store data related to merchant identifiers which are used to uniquely identify merchants. The customer-to-merchant identifiers are registered with the issuer server 110 and stored against customer account numbers associated with the customer accounts. In some embodiments, the merchant identifiers are also registered with the issuer server 110 and stored against customer account numbers associated with the customer accounts. Each customer account number may be associated with more than one customer-to-merchant identifier. A payment network database 114 is in communication with the payment network server 108, which serves at least to store data associated with issuer institutions (e.g. bank identification codes (BIN)). The computerized system 100 also comprises a merchant database 116 which is operationally connected to the merchant server 104. The merchant database 116 serves at least to store data related to customer service accounts maintained by the merchant server 104, where the customer service accounts are each associated with a customer-to-merchant identifier (e.g. a customer service account number).

Compared to conventional methods for e-commerce payment transactions, the present invention uses a customer-to-merchant identifier and a customer account number for authentication of an e-commerce payment transaction. The e-commerce payment transaction may be associated with a post-payment or bill payment for goods and/or services used. In this case, a fraudulent transaction is even less likely since the customer has already used the goods and/or services (i.e. it is unlikely that a fraudster will wish to pay for another's bill). A customer may log into a customer service account via a merchant portal associated with the merchant server 104. The customer may provide a customer identifier (ID) and a password for logging into the customer service account. The customer may be provided a number of options once he/she has logged into the customer service account. For example, the customer can select to pay a bill to the merchant or credit the customer service account via the merchant portal. Once the customer confirms the bill (e.g. by verifying a payment amount associated with the bill), the customer is typically directed to a payment page where payment details are required to be filled in to complete the e-commerce payment transaction. In an embodiment, the customer simply provides a customer account number (e.g. a payment card number) to complete payment for the e-commerce transaction (since the customer-to-merchant identifier may be known from the customer service account). In some embodiments, the customer is required to provide a customer account number, a customer-to-merchant identifier (e.g. a customer service account number) and a payment amount to complete payment.

Once the necessary payment details have been provided at the merchant portal, the customer can submit these details to initiate an e-commerce payment transaction request. In some embodiments where the customer is required to provide only the customer account number, the merchant portal is configured to retrieve the other necessary information (i.e. the customer-to-merchant identifier and the payment amount) using the log-in details and the bill confirmed by the customer. In some embodiments where the customer account number (e.g. a payment card number) is stored in association with the merchant portal, the customer is required to simply confirm a bill payment to the merchant (e.g. by simply clicking a confirmation button on the merchant portal interface) and the merchant portal is configured to retrieve all necessary information (e.g., the customer account number, the customer-to-identifier and the payment amount) to initiate the e-commerce payment transaction request. In any case, the merchant portal is configured to transmit, via the merchant server 104, a payment transaction request comprising the customer account number, the customer-to-merchant identifier and the payment amount to the payment network server 108. In some embodiments, the payment transaction request also comprises a merchant identifier associated with the merchant server 104. In these cases, the merchant identifier may be provided in the payment transaction request by the merchant server 104. The payment transaction request may be forwarded to the payment network server 108 via the acquirer server 106 or be transmitted to the payment network server 108 via the payment gateway. The payment network server 108 is configured to receive the payment transaction request.

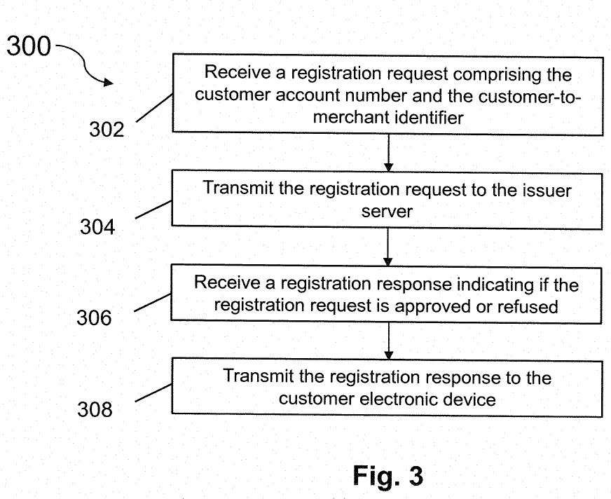

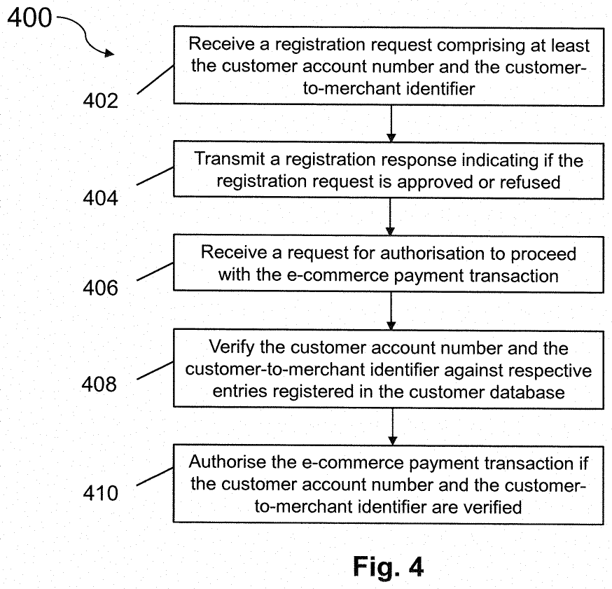

Upon receiving the payment transaction request, the payment network server 108 is configured to use the payment network database 114 to identify the issuer institution associated with the customer account number used for processing the e-commerce payment transaction. The payment network server 108 is configured to transmit a request for authorization to the issuer server 110 associated with the issuer institution identified. The request for authorization may comprise at least the customer account number and the customer-to-merchant identifier for the issuer server 110 to verify the customer account number and the customer-to-merchant identifier against respective entries in the issuer database 112 associated with the issuer server 110. Verification of the customer account number and the customer-to-merchant identifier may comprise determining if the customer account number and the customer-to-merchant identifier received in the payment transaction request match those on record in the issuer database 112. Registration of the customer-to-merchant identifier by the customer at the issuer institution is discussed later in conjunction with FIGS. 3 and 4. In some embodiments, the request for authorization may comprise the payment amount. In this case, the issuer server 110 may verify if the customer account associated with the customer account number has sufficient balance to carry out the e-commerce payment transaction. In some embodiments, the issuer server 110 transmits a secondary authentication request (e.g. dynamic one-time-password (OTP)) to the customer for further authentication prior to authorization of the e-commerce payment transaction. In other words, the present invention for authenticating e-commerce payment transactions using a customer account number and a customer-to-merchant identifier may work in combination with a dynamic OTP to provide enhanced security for the e-commerce payment transaction. This secondary authentication may apply for high-value e-commerce payment transactions which have exceeded a predetermined threshold payment amount determined by either the customer or the issuer institution. In some embodiments, the request for authorization comprises the merchant identifier. In these cases, besides the verification of the customer account number and the customer-to-merchant identifier as described above, the issuer server 110 may be configured to verify if the merchant identifier matches that on record which is registered against the customer account number and the customer-to-merchant identifier in the issuer database 112. In other words, in these embodiments, the merchant identifier, the customer-to-merchant identifier and the customer account number must match those on record in the issuer database 112 before the e-commerce payment transaction can be authorized.

After at least the customer account number and the customer-to-merchant identifier have been verified by the issuer server 110 (and any other checks performed if necessary), the issuer server 110 is configured to transmit a response for authorization to the payment network server 108, the response for authorization indicating if the e-commerce payment transaction is authorized and can proceed. The payment network server 108 receives the response for authorization, and in turn transmits a payment transaction response comprising an approval or a refusal for the e-commerce payment transaction to the merchant server 104 via the acquirer server 106. In some embodiments, the response for authorization is transmitted by the payment network server 108 to the merchant server 104 via the payment gateway (not shown). The payment transaction response may comprise the customer-to-merchant identifier which can be used by the merchant server 104 to identify the customer service account to which payment has been made. The merchant server 104 may credit the customer service account upon approval of the e-commerce payment transaction or once funds associated with the e-commerce payment transaction have been received at the merchant account. The merchant server 104 may notify the customer of a result of the e-commerce payment transaction via the merchant portal accessible via the customer electronic device 102.

Although only one customer electronic device 102 and only one merchant server 104 is shown in FIG. 1, a plurality of customer electronic devices 102 and a plurality of merchant servers 104 associated with respective e-commerce sites or merchant portals may form part of the computerized system 100. It is therefore possible that in some embodiments, a customer account number is associated with a plurality of customer-to-merchant identifiers. In these cases, it is required that each of the plurality of customer-to-merchant identifiers associated with the customer account number is different from one another. Similarly, a plurality of acquirer servers 106 and a plurality of issuer servers 110 may be in communication with the payment network server 108 and form part of the computerized system 100. Communication between the customer electronic device 102, servers 104, 106, 108, 110 and databases 112, 114, 116 may take place via any type of system, for example, a virtual private system (VPN), the Internet, a local area and/or wide area system (LAN and/or WAN), and so on. The e-commerce payment transaction as discussed and performed using the computerized system 100 may comprise any form of an electronic payment transaction (e.g. a card-not-present transaction etc.).

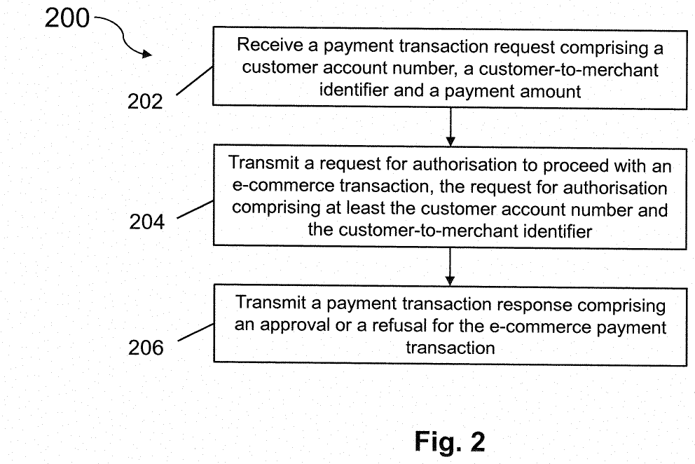

FIG. 2 shows steps of a method 200 performed at the payment network server 108 for processing an e-commerce payment transaction initiated by a customer at a merchant portal in accordance with an embodiment of the invention. The method 200 may be carried out using the system 100 as shown in FIG. 1.

In a step 202, the payment network server 108 is configured to receive a payment transaction request from the merchant server 104 associated with the merchant portal. The payment transaction request comprises a customer account number, a customer-to-merchant identifier and a payment amount. The customer account number is associated with a customer account maintained at the issuer institution. The customer-to-merchant identifier is associated with a customer service account maintained by the merchant server 104 and is pre-registered with the issuer database 112 against the customer account number prior to the payment transaction request. The payment amount is associated with the e-commerce payment transaction and is an amount which the customer is required to pay for goods and/or services purchased (e.g. a mobile data plan associated with a customer mobile device, an electricity bill, a magazine subscription etc.). The customer-to-merchant identifier may be an account number associated with the customer service account, a unique customer identifier (ID), or any string of numbers or symbols or words that uniquely associate the customer to the merchant. In some embodiments, the payment transaction request comprises a merchant identifier associated with the merchant server 104. The merchant identifier may be a name of the merchant, a business registration code of the merchant or any other information which serves to uniquely identify the merchant associated with the merchant server 104.

In a step 204, the payment network server 108 is configured to transmit a request for authorization to proceed with the e-commerce payment transaction. The request for authorization is transmitted to the issuer server 110. The authorization request comprises at least the customer account number and the customer-to-merchant identifier for the issuer server 110 to verify the customer account number and the customer-to-merchant identifier against respective entries in the issuer database 112. The e-commerce payment transaction is authorized if the customer account number and the customer-to-merchant identifier are verified. In some embodiments, the authorization request comprises the payment amount and/or the merchant identifier associated with the e-commerce payment transaction.

In a step 206, the payment network server 108 is configured to transmit, to the merchant server 104, a payment transaction response comprising an approval or a refusal for the e-commerce payment transaction. The payment network server 108 is configured to transmit the payment transaction response once it has received the response for authorization of the e-commerce payment transaction from the issuer server 110.

FIG. 3 shows steps of a method 300 performed at the payment network server 108 for registering a customer-to-merchant identifier for use in an e-commerce payment transaction in accordance with an embodiment of the invention. The method 300 may be performed prior to initiating the e-commerce payment transaction.

In a step 302, the payment network server 108 is configured to receive, from the customer electronic device 102, a registration request. The registration request comprises a request to permit authorization of the e-commerce payment transaction through the verification of the customer account number and the customer-to-merchant identifier. The registration request comprises the customer account number and the customer-to-merchant identifier. In some embodiments where the customer is provided an option to initiate the registration request via the merchant portal, the registration request is transmitted from the customer electronic device 102, via the merchant server 104, to the payment network server 108. In these cases, the registration request may be transmitted from the customer electronic device 102, via the merchant server 104 and the acquirer server 106, to the payment network server 108. In some embodiments, the customer is provided with an option to register with the payment network server 108 (e.g. through a dedicated portal hosted by the payment network server 108). In these cases, the registration request may be transmitted from the customer electronic device 102 to the payment network server 108 directly. In some embodiments, the registration request comprises a merchant identifier associated with the merchant server 104.

In a step 304, the payment network server 108 is configured to transmit, the registration request to the issuer server 110. In some embodiments where the payment network server 108 is in communication with a plurality of issuer servers 110, the registration request comprises an issuer identifier (e.g. a BIN) associated uniquely with each issuer institution. The issuer identifier serves to aid the payment network server 108 to identify the issuer server 110 for transmitting the registration request. In some embodiments where the customer account number comprises the issuer identifier (e.g. a BIN), the payment network server 108 may be configured to identify a relevant issuer server using the customer account number directly. In other words, it is not necessary in these cases for the issuer identifier to be included in the registration request sent by the customer electronic device 102.

In a step 306, the payment network server 108 is configured to receive a registration response from the issuer server 110. The registration response indicates if the registration request is approved or refused. Once the registration request is approved, the customer-to-merchant identifier is registered against the customer account number in the issuer database 112. The customer-to-merchant identifier and the customer account number may then be used for authorization of e-commerce payment transactions. In some embodiments where the merchant identifier is provided in the registration request, the merchant identifier may be registered against the customer account number in the issuer database 112. The merchant identifier may be used in combination with the customer-to-merchant identifier and the customer account number for authorization of e-commerce payment transactions.

In a step 308, the payment network server 108 is configured to transmit the registration response to the customer electronic device 102. The registration response may be transmitted to the customer electronic device 102 via the merchant server 104. The registration response received by the customer via the customer electronic device 102 notifies the customer that the registration has been successful.

FIG. 4 shows steps of a method 400 performed at the issuer server 110 for processing the e-commerce payment transaction initiated by the customer at the merchant portal in accordance with an embodiment of the invention.

In a step 402, the issuer server 110 is configured to receive, from the customer electronic device 102, a registration request comprising at least a customer account number and a customer-to-merchant identifier, the customer account number being associated with a customer account maintained at an issuer institution associated with the issuer server 110 and the customer-to-merchant identifier being associated with a customer service account maintained by the merchant server 104 associated with the merchant portal. In some embodiments, the registration request comprises a merchant identifier associated with the merchant server 104.

In a step 404, the issuer server 110 is configured to transmit, to the customer electronic device 102, a registration response indicating if the registration request is approved or refused. If the registration request is approved, the customer-to-merchant identifier is registered against the customer account number in the issuer database 112 associated with the issuer server 110. In some embodiments, the registration response comprises the customer-to-merchant identifier and the customer account number, and an indication that these details have been registered with the issuer institution associated with the issuer server 110. The registration response may indicate to the customer that the customer-to-merchant identifier has been successfully registered against the customer account number and that the customer-to-merchant identifier may be used for authentication in subsequent e-commerce payment transactions. In some embodiments where the registration request comprises the merchant identifier, the merchant identifier is registered against the customer-to-merchant identifier and the customer account number if the registration request is approved. The issuer server 110 may be configured to notify the customer via the customer electronic device 102 accordingly.

After the customer has successfully registered the customer-to-merchant identifier, he/she may proceed to initiate the e-commerce payment transaction which is to be authorized using the customer-to-merchant identifier and the customer account number. In some embodiments, the customer can proceed to initiate the e-commerce payment transaction which is authorized using the merchant identifier, the customer-to-merchant identifier and the customer account number after the merchant identifier is successfully registered with the issuer server 110. In some embodiments, more than one customer-to-merchant identifier is registered against one customer account number. In some embodiments, one customer-to-merchant identifier is registered against more than one customer account numbers. In these cases, the customer may have an option to pay or credit the customer service account associated with the one customer-to-merchant identifier using one of the more than one customer account numbers.

Once the e-commerce payment transaction is initiated by the customer at the merchant portal and the payment network server 108 has processed the e-commerce payment transaction up to the step 204 as described in relation to FIG. 2, the issuer server 110 is configured to receive a request for authorization to proceed with the e-commerce payment transaction from the payment network server 108 in a step 406. The request for authorization comprises at least the customer account number and the customer-to-merchant identifier. In some embodiments, the request for authorization may comprise the payment amount and/or the merchant identifier.

In a step 408, the issuer server 110 is configured to verify the customer account number and the customer-to-merchant identifier against respective entries registered in the issuer database 112. In some embodiments where the merchant identifier is comprised in the request for authorization, the issuer server 110 is configured to verify the merchant identifier against its respective entry registered in the issuer database 112. To verify the customer account number and the customer-to-merchant identifier received, the issuer server 110 may be configured to determine if the customer account number and the customer-to-merchant identifier in the payment transaction request match those on record in the issuer database 112. In embodiments where the request for authorization comprises the payment amount, the issuer server 110 may verify if the customer account associated with the customer account number has sufficient balance to carry out the e-commerce payment transaction. In embodiments where the request for authorization comprises the merchant identifier, to verify the customer account number, the customer-to-merchant identifier and the merchant identifier received, the issuer server 110 may be configured to determine if the customer account number, the customer-to-merchant identifier and the merchant identifier in the payment transaction request match those on record in the issuer database 112.

In a step 410, the issuer server 110 is configured to authorize the e-commerce payment transaction if at least the customer account number and the customer-to-merchant identifier are verified. In some embodiments, after the customer account number and the customer-to-merchant identifier are verified, the issuer server 110 is configured to transmit a response for authorization to the payment network server 108, where the response for authorization indicates if the e-commerce payment transaction is authorized and can proceed. The payment network server 108 may then transmit the payment transaction response in the step 206 to the customer via the customer electronic device 102 to notify the customer of the result. In some embodiments, the issuer server 110 is configured to transmit the response for authorization to the customer electronic device 102 directly. In embodiments where additional checks or verifications (e.g. verification of the merchant identifier and/or a balance of the customer account) are performed at the issuer server 110, the issuer server 110 is configured to authorize the e-commerce payment transaction if conditions for these additional checks or verifications are met.

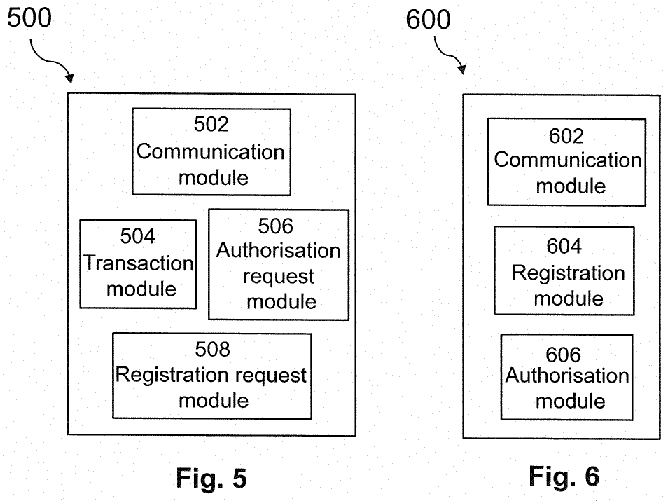

FIG. 5 shows schematically a structure 500 of the payment network server 108 comprised in the computerized system 100 in accordance with embodiments of the invention. The structure 500 of the payment network server 108 comprises at least a communication module 502, a transaction module 504, an authorization request module 506 and a registration request module 508.

The communication module 502 is configured to enable the payment network server 108 to communicate with at least the acquirer server 106 and the issuer server 110 as provided in the computerized system 100. In some embodiments, the communication module 502 is configured to enable the payment network server 108 to communicate with the merchant server 104 and/or the customer electronic device 102. The communication module 502 is configured to work in tandem with other modules of the payment network server 108 as discussed in more detail below.

The transaction module 504 is configured, via the communication module 502, to receive the payment transaction request from the merchant server 104 associated with the merchant portal. The payment transaction request comprises at least a customer account number, a customer-to-merchant identifier and a payment amount. The customer account number is associated with a customer account maintained at an issuer institution and the customer-to-merchant identifier is associated with a customer service account maintained by the merchant server 104. The customer-to-merchant identifier is pre-registered with an issuer database 112 against the customer account number prior to the payment transaction request. In some embodiments, the payment transaction request comprises the merchant identifier. After the e-commerce payment transaction has been processed, the transaction module 504 is configured, via the communication module 502, to transmit a payment transaction response comprising an approval or a refusal for the e-commerce payment transaction to the merchant server 104.

The authorization request module 506 is configured to transmit, via the communication module 502, a request for authorization to proceed with the e-commerce payment transaction to the issuer server 110. The request for authorization comprises at least the customer account number and the customer-to-merchant identifier for the issuer server 110 to verify the customer account number and the customer-to-merchant identifier against respective entries in the issuer database 112 associated with the issuer server 110. The e-commerce payment transaction is authorized if the customer account number and the customer-to-merchant identifier are verified. In some embodiments, the request for authorization comprises the merchant identifier which is used to verify if the merchant identifier received matches its respective entry in the issuer database 112. This may be performed in conjunction with the verification using the customer account number and the customer-to-merchant identifier. In these cases, the e-commerce payment transaction is authorized if a combination of the merchant identifier, the customer account number and the customer-to-merchant identifier is verified.

The registration request module 508 is configured to receive, via the communication module 502, the registration request from the customer electronic device 102. The registration request is a request to permit authorization of an e-commerce payment transaction through the verification of the customer account number and the customer-to-merchant identifier, and comprises at least the customer account number and the customer-to-merchant identifier. In some embodiments, the registration request comprises the merchant identifier. The registration request module 508 is configured to transmit the registration request to the issuer server 110 and to receive a registration response from the issuer server 110. These actions may be performed via the communication module 502. The registration response serves to indicate if the registration request is approved or refused. If the registration request is approved, the customer-to-merchant identifier is registered against the customer account number in the issuer database 112 associated with the issuer server 110. In embodiments, where the registration request comprises the merchant identifier, the merchant identifier is registered against the customer-to-merchant identifier and the customer account number if the registration request is approved. The registration request module 508 is configured to transmit, via the communication module 502, the registration response to the customer electronic device 102.

FIG. 6 shows schematically a structure 600 of the issuer server 110 comprised in the computerized system 100 in accordance with embodiments of the invention. The structure 600 of the issuer server 110 comprises a communication module 602, a registration module 604 and an authorization module 606.

The communication module 602 is configured to enable the issuer server 110 to communicate with at least the payment network server 108 and the customer electronic device 102 as provided in the computerized system 100. The communication module 602 is configured to work in tandem with other modules of the issuer server 110 as discussed in more detail below.

The registration module 604 is configured to register customer-to-merchant identifiers against customer account numbers for authorization of e-commerce payment transactions. In particular, the registration module 604 may be configured to receive, via the communication module 602, the registration request from the customer electronic device 102. The registration request may be received from the customer electronic device 102 directly, or it may be received from the customer electronic device 102 via the payment network server 108. The registration request comprises at least a customer account number and a customer-to-merchant identifier, the customer account number being associated with a customer account maintained at an issuer institution associated with the issuer server 110 and the customer-to-merchant identifier being associated with a customer service account maintained by the merchant server 104 associated with the merchant portal. In some embodiments, the registration request comprises the merchant identifier. Once the registration has been processed, the registration module 604 may be configured to transmit, via the communication module 602, a registration response indicating if the registration request is approved or refused to the customer electronic device 102. If the registration request is approved, the customer-to-merchant identifier is registered against the customer account number in the issuer database 112 associated with the issuer server 110. In embodiments where the merchant identifier is also provided with the registration request, the registration module 604 is configured to register the merchant identifier and the customer-to-merchant identifier against the customer account number in the issuer database 112.

The authorization module 606 is configured to authorize the e-commerce payment transaction if at least the customer-to-merchant identifier and the customer account number are verified. The authorization module 606 may be configured to receive, via the communication module 602, the request for authorization to proceed with the e-commerce payment transaction from the payment network server 108. The request for authorization comprises at least the customer account number and the customer-to-merchant identifier. In some embodiments, the request for authorization comprises the payment amount associated with the e-commerce payment transaction and/or the merchant identifier. To authorize the e-commerce payment transaction, the authorization module 606 is configured to verify the customer account number and the customer-to-merchant identifier against respective entries registered in the issuer database 112. In embodiments where the merchant identifier is provided in the request for authorization, the authorization module 606 is configured to verify the merchant identifier against its respective entry registered in the issuer database 112. In embodiments where the payment amount is provided in the request for authorization, the authorization module 606 is configured to determine if the customer account associated with the customer account number has sufficient balance to carry out the e-commerce payment transaction. The authorization module 606 is configured to authorize the e-commerce payment transaction if at least the customer account number and the customer-to-merchant identifier are verified. In embodiments where verification of the merchant identifier is required, the e-commerce payment transaction is authorized if the merchant identifier, the customer-to-merchant identifier and the customer account number are verified. In some embodiments, the e-commerce payment transaction is verified if there is sufficient balance in the customer account associated with the customer account number.

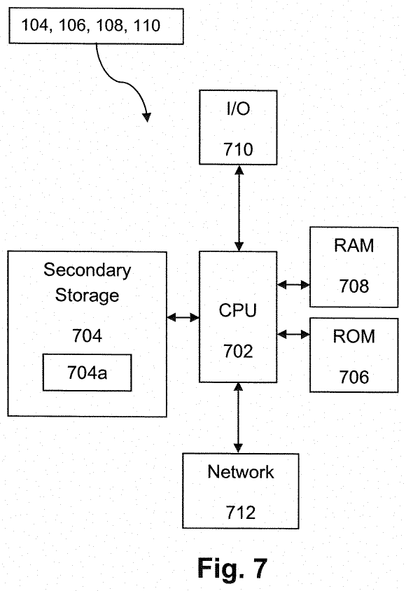

FIG. 7 is a block diagram showing a technical architecture of the payment network server 108. The issuer server 110 and/or the acquirer server 106 may also have this technical architecture. The merchant server 104 may share a similar technical architecture.

The technical architecture includes a processor 702 (which may be referred to as a central processor unit or CPU) that is in communication with memory devices including secondary storage 704 (such as disk drives), read only memory (ROM) 706, and random access memory (RAM) 708. The processor 702 may be implemented as one or more CPU chips. The technical architecture may further comprise input/output (I/O) devices 710, and system/network connectivity devices 712.

The secondary storage 704 is typically comprised of one or more disk drives or tape drives and is used for non-volatile storage of data and as an over-flow data storage device if RAM 708 is not large enough to hold all working data. Secondary storage 704 may be used to store programs which are loaded into RAM 708 when such programs are selected for execution.

In this embodiment, the secondary storage 704 has a processing component 704a comprising non-transitory instructions operative by the processor 702 to perform various operations of the method of the present disclosure. The ROM 706 is used to store instructions and perhaps data which are read during program execution. The secondary storage 704, the RAM 708, and/or the ROM 706 may be referred to in some contexts as computer readable storage media and/or non-transitory computer readable media.

I/O devices 710 may include printers, video monitors, liquid crystal displays (LCDs), plasma displays, touch screen displays, keyboards, keypads, switches, dials, mice, track balls, voice recognizers, card readers, paper tape readers, or other input devices.

The system/network connectivity devices 712 may take the form of modems, modem banks, Ethernet cards, universal serial bus (USB) interface cards, serial interfaces, token ring cards, fiber distributed data interface (FDDI) cards, wireless local area system (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other system devices. These system/network connectivity devices 712 may enable the processor 702 to communicate with the Internet or one or more intranets. With such a system connection, it is contemplated that the processor 702 might receive information from the system, or might output information to the system in the course of performing the above-described method operations. Such information, which is often represented as a sequence of instructions to be executed using processor 702, may be received from and outputted to the system, for example, in the form of a computer data signal embodied in a carrier wave.

The processor 702 executes instructions, codes, computer programs, scripts which it accesses from hard disk, floppy disk, optical disk (these various disk based systems may all be considered secondary storage 704), flash drive, ROM 706, RAM 708, or the system/network connectivity devices 712. While only one processor 702 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing an application and/or applications in a cloud computing environment. Cloud computing may comprise providing computing services via a system connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 702, the RAM 708, and the ROM 706 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Embodiments of the present invention therefore provide a system and method for authorizing an e-commerce payment transaction simply based on a verification of a pre-registered customer-to-merchant identifier with a customer account number. This advantageously minimizes processing time for an e-commerce payment transaction by at least reducing a number of processing steps (e.g. a step of authorization involving an OTP), increasing convenience for the customer, while maintaining a balanced level of security for authenticating the e-commerce payment transaction (since only a pre-registered customer-to-merchant identifier will be recognized). Moreover, embodiments of the invention advantageously use present infrastructure for processing the e-commerce payment transaction using the customer-to-merchant identifier so that minimal costs will be incurred to implement the above. The primary set-up required is to maintain records of customer-to-merchant identifiers against customer account numbers at the issuer server which can be easily implemented using existing memory storages, servers and/or databases.

Whilst the foregoing description has described exemplary embodiments, it will be understood by those skilled in the art that many variations of the embodiments can be made within the scope of the present invention as defined by the claims. Moreover, features of one or more embodiments may be mixed and matched with features of one or more other embodiments.

What is claimed is:

1. A payment network server for processing an electronic commerce (e-commerce) payment transaction initiated by a customer at a merchant portal, the server comprising:
a transaction module configured to:
receive, from a merchant server associated with the merchant portal, a payment transaction request comprising a customer account number, a customer-to-merchant identifier and a payment amount, the customer account number being associated with a customer account maintained at an issuer institution and the customer-to-merchant identifier being associated with a customer service account maintained by the merchant server and being pre-registered with an issuer database against the customer account number prior to the payment transaction request; and
transmit, to the merchant server, a payment transaction response comprising an approval or a refusal for the e-commerce payment transaction; and
an authorization request module configured to:
transmit, to an issuer server associated with the issuer institution, a request for authorization to proceed with the e-commerce payment transaction, the request for authorization comprising at least the customer account number and the customer-to-merchant identifier for the issuer server to verify the customer account number and the customer-to-merchant identifier against respective entries in the issuer database, such that the e-commerce payment transaction is authorized if the customer account number and the customer-to-merchant identifier are verified.

2. The server of claim 1, further comprising a registration request module configured to:
receive, from a customer electronic device, a registration request comprising the customer account number and the customer-to-merchant identifier, the registration request being a request to permit authorization of the e-commerce payment transaction through the verification of the customer account number and the customer-to-merchant identifier;
transmit, the registration request to the issuer server;
receive, a registration response from the issuer server, the registration response indicating if the registration request is approved or refused, the customer-to-merchant identifier is registered against the customer account number in the issuer database associated with the issuer server if the registration request is approved; and
transmit, the registration response to the customer electronic device.

3. The server of claim 1, wherein the payment transaction response further comprises the customer-to-merchant identifier.

4. The server of claim 1, wherein the customer account number is associated with a plurality of customer-to-merchant identifiers.

5. The server of claim 1, wherein the e-commerce payment transaction is associated with a post-payment for goods or services used.

6. The server of claim 1, wherein the customer-to-merchant identifier is one of the following: a customer service account number, a name of the customer, a mobile number of the customer, a security number, an identity card number, a passport number, and a string of one or more alphanumeric symbols or characters.

7. A computer-implemented method performed at a payment network server for processing an electronic commerce (e-commerce) payment transaction initiated by a customer at a merchant portal, the method comprising:
receiving, from a merchant server associated with the merchant portal, a payment transaction request comprising a customer account number, a customer-to-merchant identifier and a payment amount, the customer account number being associated with a customer account maintained at an issuer institution and the customer-to-merchant identifier being associated with a customer service account maintained by the merchant server and being pre-registered with an issuer database against the customer account number prior to the payment transaction request;
transmitting, to an issuer server associated with the issuer institution, a request for authorization to proceed with the e-commerce payment transaction, the request for authorization comprising at least the customer account number and the customer-to-merchant identifier for the issuer server to verify the customer account number and the customer-to-merchant identifier against respective entries in the issuer database such that the e-commerce payment transaction is authorized if the customer account number and the customer-to-merchant identifier are verified; and
transmitting, to the merchant server, a payment transaction response comprising an approval or a refusal for the e-commerce payment transaction.

8. The method of claim 7, further comprising:
receiving, from a customer electronic device, a registration request comprising the customer account number and the customer-to-merchant identifier, the registration request being a request to permit authorization of the e-commerce payment transaction through the verification of the customer account number and the customer-to-merchant identifier;
transmitting, the registration request to the issuer server;
receiving, a registration response from the issuer server, the registration response indicating if the registration request is approved or refused, the customer-to-merchant identifier is registered against the customer account number in the issuer database associated with the issuer server if the registration request is approved; and
transmitting, the registration response to the customer electronic device.

9. The method of claim 7, wherein the payment transaction response further comprises the customer-to-merchant identifier.

10. The method of claim 7, wherein the customer account number is associated with a plurality of customer-to-merchant identifiers.

11. The method of claim 7, wherein the e-commerce payment transaction is associated with a post-payment for goods or services used.

12. The method of claim 7, wherein the customer-to-merchant identifier is one of the following: a customer service account number, a name of the customer, a mobile number of the customer, a security number, an identity card number, a passport number, and a string of one or more alphanumeric symbols or characters.

13. A non-transitory computer-readable medium having stored thereon program instructions for causing at least one processor to perform the method according to claim 7.

14. A computer-implemented method performed at an issuer server for processing an electronic commerce (e-commerce) payment transaction initiated by a customer at a merchant portal, the method comprising:
receiving, from a customer electronic device, a registration request comprising at least a customer account number and a customer-to-merchant identifier, the customer account number being associated with a customer account maintained at an issuer institution associated with the issuer server and the customer-to-merchant identifier being associated with a customer service account maintained by a merchant server associated with the merchant portal;
transmitting, to the customer electronic device, a registration response indicating if the registration request is approved or refused, the customer-to-merchant identifier is registered against the customer account number in an issuer database associated with the issuer server if the registration request is approved;
receiving, from a payment network server, a request for authorization to proceed with the e-commerce payment transaction, the request for authorization comprising at least the customer account number and the customer-to-merchant identifier;
verifying the customer account number and the customer-to-merchant identifier against respective entries registered in the issuer database; and
authorizing the e-commerce payment transaction if the customer account number and the customer-to-merchant identifier are verified.

15. The method of claim 14, wherein the customer account number is associated with a plurality of customer-to-merchant identifiers.

16. The method of claim 14, wherein the e-commerce payment transaction is associated with a post-payment for goods or services used.

17. The method of claim 14, wherein the customer-to-merchant identifier is one of the following: a customer service account number, a name of the customer, a mobile number of the customer, a security number, an identity card number, a passport number, and a string of one or more alphanumeric symbols or characters.

18. A non-transitory computer-readable medium having stored thereon program instructions for causing at least one processor to perform the method according to claim 14.
